(19) United States
(12) Patent Application Publication
(10) Pub. No.: US 2008/0172145 A1
(43) Pub. Date: Jul. 17, 2008

(54) METHOD OF PRODUCING MAILING COVERS AND MACHINE UTILIZING SAID METHOD

(75) Inventors: Hubert FREYBURGER, Colmar (FR); Thierry FREBOURG, Labaroche (FR)

Correspondence Address: DAVIS BUJOLD & Daniels, P.L.L.C., 112 PLEASANT STREET, CONCORD, NH, 03301, US

(73) Assignee: MEGASPIREA PRODUCTION, Colmar (FR)

(21) Appl. No.: 12/019,801

(22) Filed: Jan. 25, 2008

Related U.S. Application Data
(60) Provisional application No. 60/898,573, filed on Jan. 31, 2007.

(30) Foreign Application Priority Data
Jul. 25, 2005 (FR) 05/07877

(51) Int. Cl. G05B 19/042

(52) U.S. Cl. 700/233; 270/58.06; 270/58.07

(57) ABSTRACT

A method for producing unique and personalized pieces of mail, including integrating envelope production with the production of the documents for insertion within the envelopes. The machine for producing the pieces of mail includes a device for producing, from the same width of paper, both the documents and the envelopes designed to contain the documents. A longitudinal cutting device cuts the documents to the correct width and forms the flaps of the envelopes. A transverse cutting device separates the documents from the envelopes and cuts them to the correct length. A device assembles the documents with the corresponding envelope. A gluing and folding device closes the envelope while a central processing unit regulates at least the cutting devices, according to the number and format of the documents, and the stuffed envelopes to be produced.

The present invention concerns a method for producing unique and personalized mail pieces, offering a complete solution integrating envelope production with production of the documents for insertion, enabling high speed production, guaranty mail integrity and confidentiality, and reduced global unitary cost. The machine (1) for producing mail pieces (100) specifically comprises a printing device (2) for printing from the same width of paper (10) both the documents (13) to be inserted and the envelopes (14) designed to contain the documents (13), one after the other in the order of insertion, each envelope being preceded or followed by the document or documents it will contain; a longitudinal cutting device (3) for cutting the documents (13) to the correct width and forming the flaps (16) of the envelopes (14); a transverse cutting device (4) for separating the documents (13) from the envelopes (14) and cutting them to the correct length; a device (7, 8) for assembling the documents (13) with the corresponding envelope (14); a gluing and folding device (9) for folding the piece of mail thus obtained (100); and a central processing unit that regulates at least the cutting devices according to the number and format of the documents and the stuffed envelopes to be produced. Application: Mass mailings such as routing, transactional mail, hybrid mail.

### TECHNICAL FIELD

The present invention concerns a method of producing mail piece beginning with a width of material, especially paper or similar material, and ending with a closed piece of mail, each piece of mail consisting of at least one printed document and one printed envelope, with the number and format of the documents and envelopes varying from one piece of mail to the next, as well as a machine utilizing this method.

### PRIOR ART

Mail production machines, automated to a greater or lesser extent, are in widespread use by enterprises that must produce large volumes of mail, such as several thousand pieces a day. This is the case in particular with banks, insurance companies, public entities, direct mail houses, mail routing organizations, etc. “Routing”, “transactional mail”, or “hybrid mail” are commonly used terms. In the case of “routing”, the documents being sent are identical documents for a given advertising campaign and are generally personalized with the recipient's identity. With “transactional mail”, each piece is unique and the documents it contains are personal and confidential for each recipient, such as statements, bills, insurance policies, etc. With “hybrid mail”, each piece is unique in that the contents are generated by the customer himself through an Internet network and sent to a publishing and distribution company.

With the usual methods, the information to be mailed is printed on a roll of paper, such as the sender's identity, its logo, the recipient's identity, text, charts, and/or images. The width of paper is unrolled, printed using a known method such as laser, inkjet, offset, etc, and re-rolled. The roll of printed paper then feeds a mail inserter machine which cuts the width of paper transversely into sheets, for example, into A4 format, to form the documents to be inserted. The different sheets comprising the insert are grouped and then sent to an insertion station. Likewise, the envelopes stored in a storage unit are moved along to the insertion station. These envelopes are manufactured separately and then printed with the sender's identity and logo. They may be window envelopes revealing the recipient's identity printed on the document or envelopes without windows requiring an individual label to identify the recipient. At the insertion station, the envelope is opened to introduce one or more documents previously folded to fit the envelope format. The envelope is then closed, glued, and posted. The processed stuffed mail is then placed upright or vertically on a discharge conveyor before being dispatched. The mailings may be completed with any type of additional document, such as prospectuses and other advertising material printed in volume and stored in additional storage compartments supplying the insertion station. A code may also be added by printing numbers, bar codes, or the like on the envelope to track its progress.

Currently used techniques are not ideal, given the number of preparatory operations to be performed in order to produce a sealed piece ready for mailing, namely, preparing and assembling the documents to be sent, on the one hand, and the envelopes, on the other hand. Moreover, the techniques do not guaranty the integrity of the enclosures prepared this way, as the documents inserted in the envelopes are not necessarily the correct ones, which causes confidentiality problems.

Some process propose to print the documents and the envelopes one after the other in the order of insertion, but the stuffed mail that is produced is all identical, as in publications U.S. Pat. No. 4,071,997; U.S. Pat. No. 4,189,895; US 2003/0222127. No method exists for producing unique pieces of mail that differ from one another in format as well as in the number of documents they contain.

As a conclusion, at this time there is no complete method of producing mail pieces that begins with the spool of paper and ends with the sealed envelope, resulting in unique, personalized mailings.

### DESCRIPTION OF THE INVENTION

The aim of the present invention is to overcome these disadvantages by proposing a method to produce personalized and unique mails, offering a complete solution beginning with a roll of paper and ending with a sealed piece of mail, integrating envelope production with document production, allowing production at higher speeds than are currently possible, ensuring the integrity and confidentiality of the mail thus produced, and reducing the global unit cost of the mail.

For this purpose, the invention concerns a production method of the type indicated in the preamble in which the documents to be enclosed and the envelopes destined to contain them are printed on the same width of material, one after the other in the order of insertion, each envelope being preceded or followed by the documents it will contain; the longitudinal edges of the width of material are trimmed to make the documents the correct width and to form the envelope flaps; the width of material is cut transversely to separate the documents and the envelopes from one another and make them the correct length; the documents are assembled with their corresponding envelope, the piece of mail thus obtained is closed, and at least the cutting operations are controlled according to the number and format of the documents and the stuffed envelope to be produced.

It is possible to perform the document and envelope printing operations separately from the other steps or conversely, in a continuous manner.

It is possible to print two parallel strips of documents and envelopes on the same width of material to double production.

Before the assembly step, the documents are advantageously separated from the envelopes in two distinct circuits and the documents destined to be contained in the same envelope are superimposed in packets.

In the assembly step the document or documents are superimposed on the corresponding envelope and they are folded simultaneously, or else the document or documents destined to be contained in the same envelope are folded first into the format of the envelope and then the envelope is folded around the folded documents.

It is also possible to superimpose additional documents that have been separately prepared on the documents and on the envelope.

For the same purpose, the invention also concerns a production machine of the type described in the preamble, characterized in that it comprises at least one printing device for printing on the same width of material the documents to be enclosed and the envelopes destined to contained the documents, one after the other in the order of insertion, each envelope being preceded or followed by the document(s) it will contain; a longitudinal cutting device to make the documents the correct width and to form the envelope flaps; a transverse cutting device to separate the documents and the envelopes while making them the correct length; a device for assembling the documents with their corresponding envelope; a gluing and folding device to close the piece of mail obtained; and a central processor to control at least the cutting devices according to the number and format of the documents and the mailing envelope to be produced.

The printing device may be separated from the other devices or conversely, it may be integrated with and on line with the other devices.

The assembly device preferably comprises at least one accumulator to separate the documents from the envelopes into two distinct accumulator circuits and assemble them by superimposing the documents on the corresponding envelopes. If several documents are destined to be contained in the same envelope, then they are superimposed in a packet beforehand.

According to a first variation, the assembly device comprises at least one insertion device designed to fold the documents and the envelope simultaneously.

According to a second variation, the accumulator device comprises a folding system for folding said documents to conform to the envelope format, and the assembly device comprises at least one insertion device for folding the envelope around said folded documents.

The insertion device comprises at least one storage unit for additional separately prepared documents designed to add at least one additional document to the corresponding documents and envelope.

The production machine may be completed by a postage machine for the sealed mail, a integrity control device, etc.

### SUMMARY DESCRIPTION OF THE DRAWINGS

The advantages of the present invention will be more readily apparent from the following description of one embodiment given by way of non-limiting example, with reference to the attached drawings, in which:

FIG. 1 is a schematic perspective of the production machine according to the invention;

FIG. 1A is an enlarged perspective of a portion of the production machine of FIG. 1;

FIG. 1B is an enlarged perspective of a section of the production machine represented in FIGS. 1 and 1A:

FIG. 1C is an enlarged perspective of a detail of the production machine represented in FIGS. 1, 1A, and 1B:

FIG. 1D is an enlarged perspective of specific components of the detail in the view of FIG. 1C;

FIG. 1E represents a cross-section of the components of FIG. 1C;

FIGS. 2A and 2B are overhead views of two widths of paper on which one strip and two strips of documents and envelopes are printed, respectively, one after the other;

FIG. 2C is a variation of the width of paper in FIG. 2B;

FIG. 2D represents an envelope originating from the width of paper in FIG. 2C with the scoring and cutting marks; and

FIG. 2E represents the envelope of FIG. 2D identifying the utility zones for marking and indexing the envelope.

### ILLUSTRATIONS OF THE INVENTION AND BEST WAY OF ACHIEVING THE INVENTION

With reference to the drawings, production machine 1 for mail pieces 100, according to the invention, is designed to implement a novel production method principally consisting in:

a) printing on the same width of material 10, specifically paper or a similar material, the documents 13 to be inserted and the envelopes 14 destined to contain these documents 13, one after the other in the order of insertion, each envelope 14 being preceded or followed by the documents 13 it will contain, with the number and format of the documents and the envelope possibly varying from one piece of mail to the next;

b) trimming the longitudinal edges of this width of material 10 to make documents 13 the appropriate width and to form the lateral flaps 16 on envelopes 14;

c) transversely cutting the width of material 10 in order to separate documents 13 from envelopes 14 and make them the correct width, with the length of documents 13 possibly being different from that of envelopes 14;

d) assembling documents 13 with corresponding envelope 14;

e) closing the piece mail 100 thus obtained so it is ready to be dispatched; and

f) regulating at least the transverse cutting operations in accordance with the number and format of the documents and of the envelopes to be produced.

Each piece of mail 100 consists in at least one printed document 13 in the form of one A4 format sheet, for example, and one envelope 14 in 110×220, 162×229 format, for example, or any other format.

To achieve this, said production machine 1 comprises at least the following working zones:
a printing zone A where documents 13 and envelopes 14 are printed in black and white or color proceeding continuously in a predefined order on a width of paper 10;
a cutting zone B where documents 13 and envelopes 14 with different dimensions are made into the desired format with respect to length and width;
an assembly zone C where the document(s) 13 at are assembled with a corresponding envelope 14 and they are folded simultaneously or not;
a closing zone D where lateral flaps 16 and closing flap 17 of envelope 14 are glued and folded to close envelope 14 around documents 13;
a storage zone E where the closed pieces of stuffed mail 100 are stored, controlled and/or posted before being dispatched; and
a central processing unit (not shown) for regulating at least the cutting steps according to the number and format of documents and envelopes to be produced.

Additionally, it has been noted that certain printing machines are designed to work repetitively with paper having the same format. For this reason, if documents 13 are printed on segments of A4 format material, envelopes 14 will also be printed on, and consequently formed by folding, A4 format segments. Conversely, if documents 13 are printed on segments of material having a format different than A4, envelopes 14 will also be printed on, and consequently formed by folding, segments having a format different than A4. The drawback to the constraint imposed by certain printing machines is that the closing flap 17 of an envelope 14, when the envelope format is adapted to A4 documents folded in thirds, for example, is too large relative to conventional flaps on envelopes of this format. To eliminate this purely esthetic concern, it is possible to complete the steps of the method described above with steps of scoring the closing flap on the envelope, partially gluing this flap, and trimming away the excess flap before folding it down on the back of the envelope to enclose the corresponding insert.

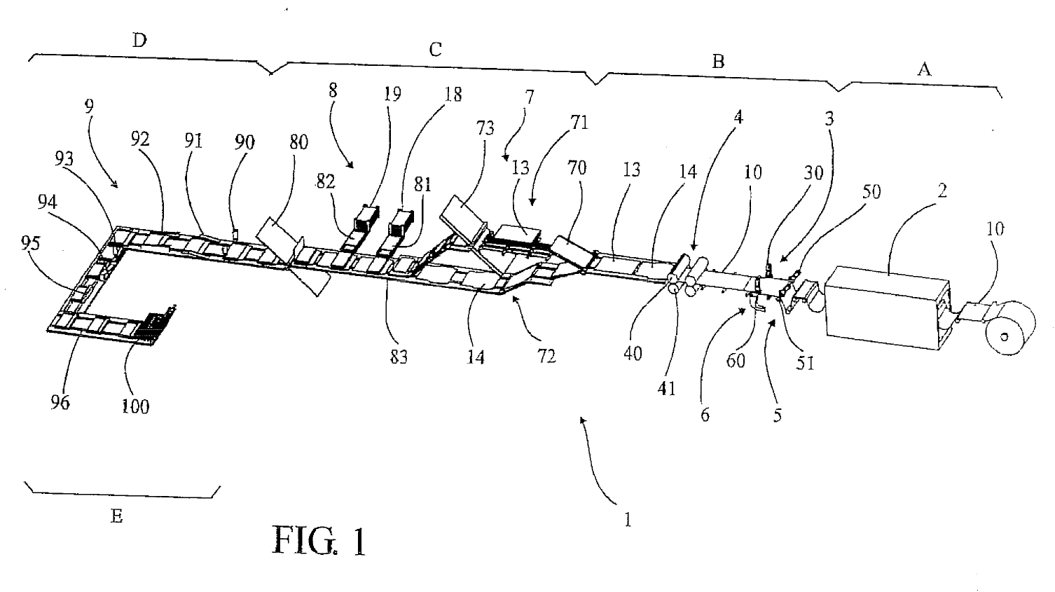

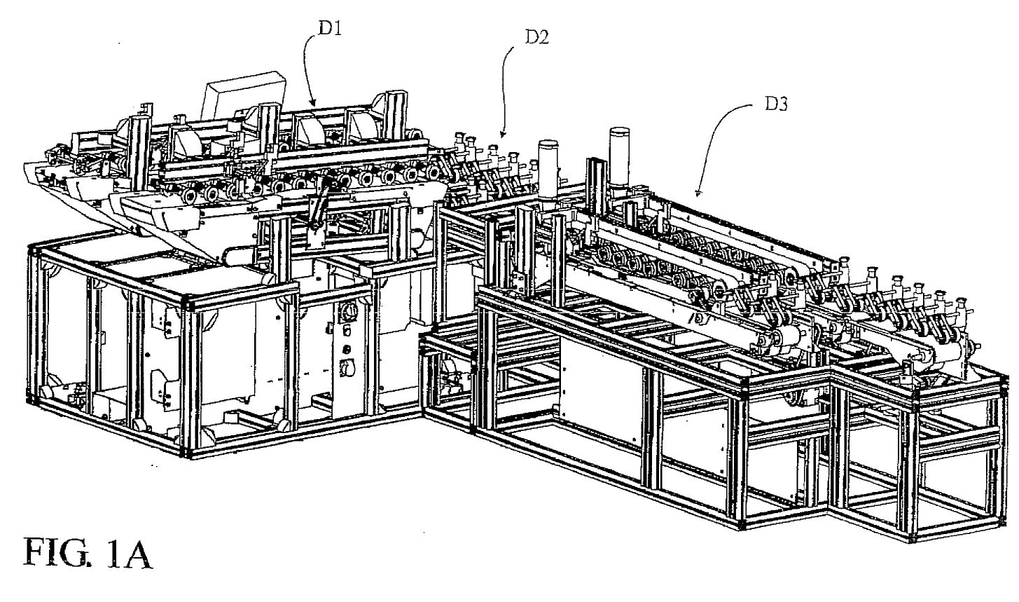

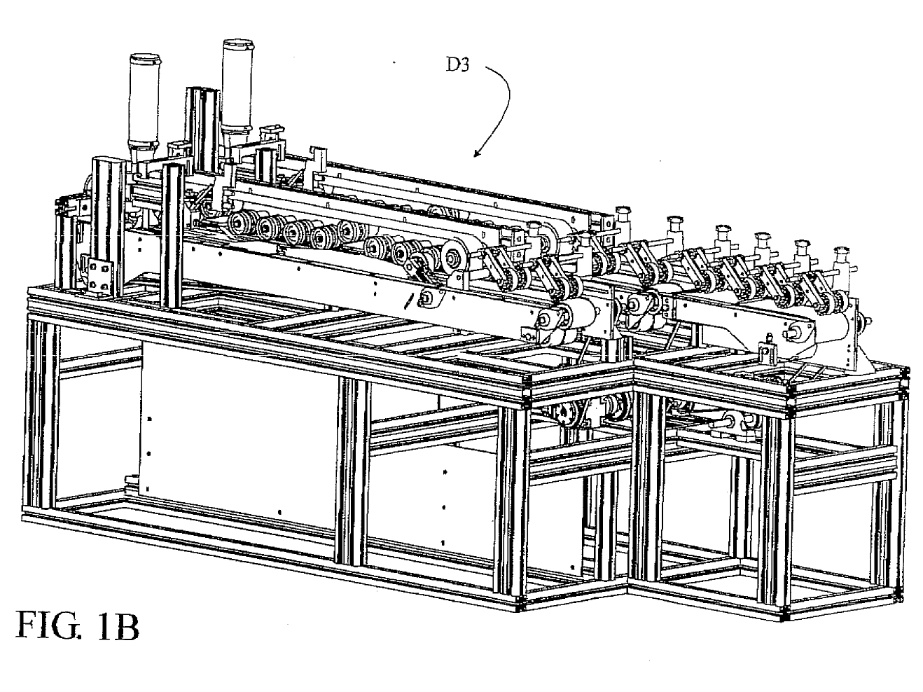

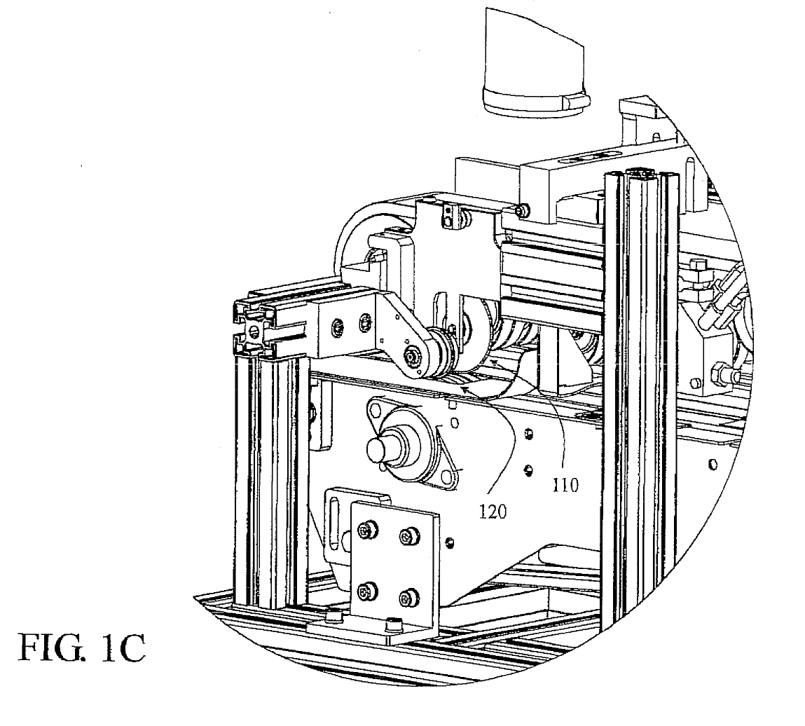

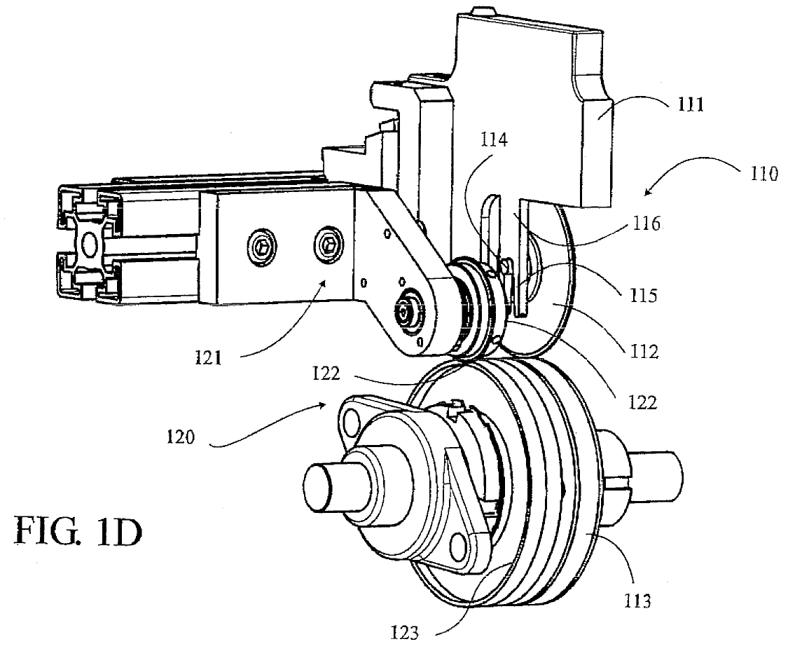

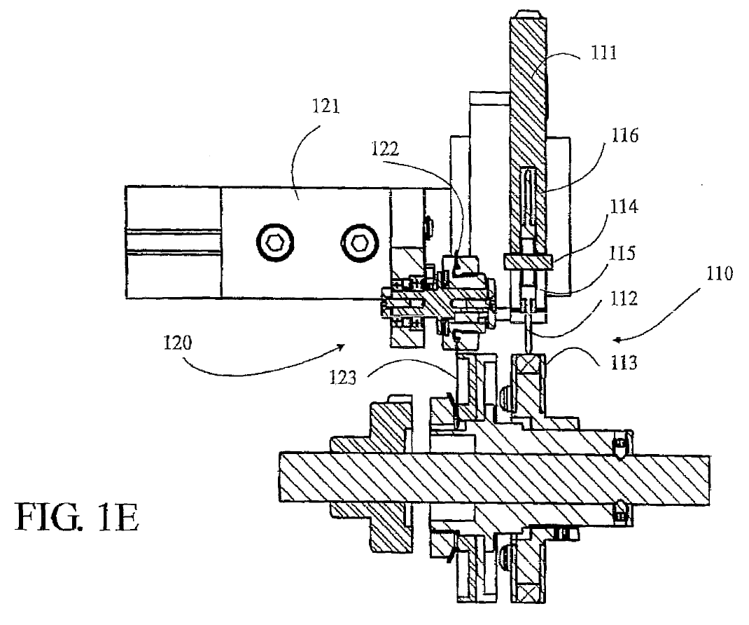

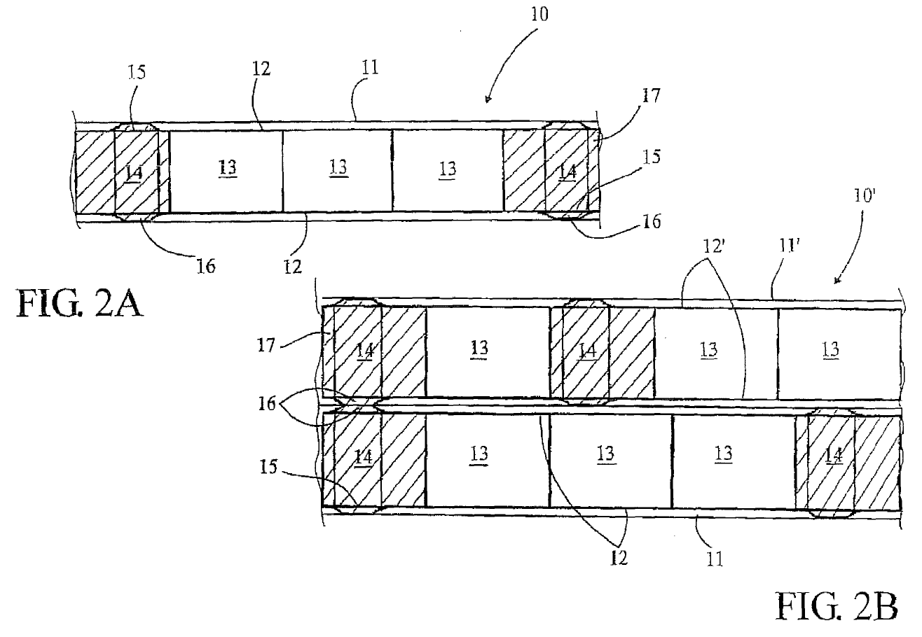

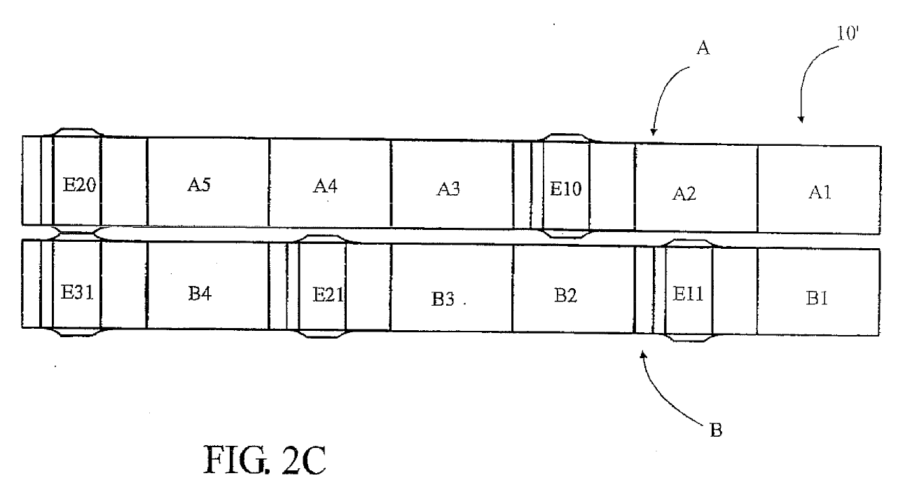

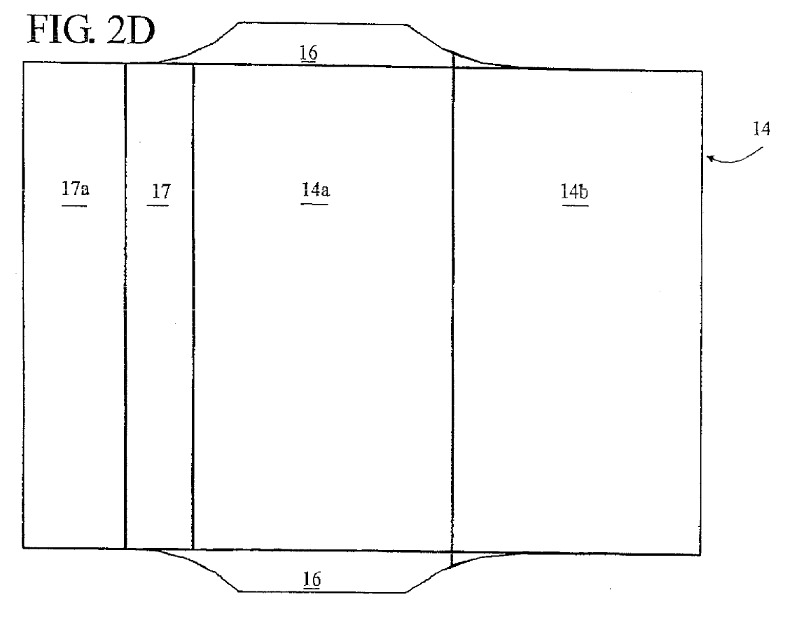

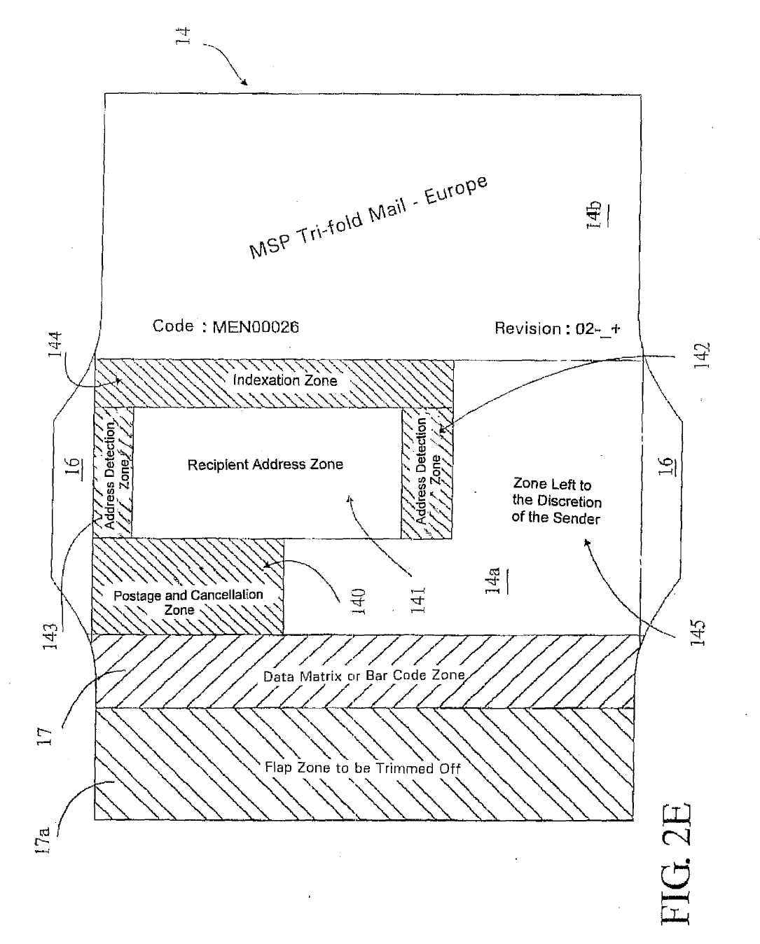

In this case, closing zone D where lateral flaps 16 and closing flap 17 of envelope 14 are glued and they are folded to close envelope 14 around documents 13, is divided into several sections with distinct complementary functions. The steps defined above and the corresponding working zones will be described in more detail with reference to FIGS. 1A through 1E and 2C through 2E. Briefly, production machine 1 comprises one zone D1 for scoring, gluing, and folding lateral flaps 16, then an angled return zone D2, and finally a zone D3 for scoring and gluing closing flap 17, cutting off the excess 17a if necessary on this closing flap 17 (see FIG. 2D), evacuating said surplus 17a and folding and sealing closing flap 17.

Printing zone A specifically comprises a printing device 2 supplied with a roll of blank paper supported by a unwinder (not shown) and delivering a width of printed paper 10 to its destination in cutting zone B. This printing device 2 is a known type, for example, based on a laser, inkjet, offset, or similar printing technique, black and white or color. This printing device 2 may be disconnected from the rest of production machine 1 or conversely, it may be integrated as in the example illustrated. If it is not connected, the width of printed paper 10 is then rewound on a roll by a winding device in order to supply cutting zone B.

Cutting zone B specifically comprises a longitudinal cutting device 3 and a transverse cuffing device 4. It may be completed by a scoring device 5 and a suction device 6.

Longitudinal cutting device 3 principally comprises two cutting tools 30 cooperating with a counter-piece, disposed on either side of the width of paper 10 and cutting away the longitudinal edges or borders of width of paper 10 to form a strip of paper 11 from which documents 13 are cut to width and the lateral flaps 16 of envelopes 14 are created, the latter exceeding the width of documents 13. This strip of paper 11 is, consequently, defined by a variable longitudinal profile 12 that is not rectilinear and not repetitive, since the number and size of documents 13 and/or of envelopes 14 may vary from one piece of mail 100 to the next. Longitudinal cutting device 3 is controlled by the central processor that is regulated according to the profiles 12 to be cut, with the cut width of envelopes 14 varying from that of documents 13, and the cut widths possibly varying from one piece of mail to the next.

FIG. 2A illustrates a first sample of a width of paper 10 from which a strip 11 is cut comprising two envelopes 14 and three documents 13. FIG. 2B illustrates a second sample of a double width of paper 10′ from which two strips 11, 11′ are cut, each comprising two envelopes 14 and three documents 13, offset from one another, each strip 11, 11′ having its own profile 12, 12′ If the width of paper 10′ is double, longitudinal cutting device 3 is doubled, as are scoring devices 5 and suction devices 6.

Transverse cutting device 4 principally comprises a rotating cylinder with a blade 40 cooperating with a counter-cylinder 41, or any other similar cuffing tool, for separating documents 13 from envelopes 14 in order to supply assembly zone C. Transverse cuffing device 4 is controlled by the central processor regulated according to the formats to be cut, with the cut length of envelopes 14 being different from that of documents 13, and the cut lengths possibly varying from one piece of mail to the next.

Scoring device 5 located upstream of longitudinal cutting device 3 principally comprises two discs 50 cooperating with a counter-piece 51, or any other similar system, located on either side of width of paper 10 and marking a pre-fold 15 on lateral flaps 16 of envelopes 14 to facilitate the subsequent folding operation.

Suction device 6 principally comprises suction nozzles 60 located near cutting tools 30 to automatically evacuate the waste paper generated by longitudinal cutting device 3 into a storage container through a central suction device (not shown).

Naturally, printing zone A and cutting zone B are completed by stretching devices with rollers to simultaneously control tension and positioning of width of paper 10 in order to ensure precise cuffing.

Assembly zone C specifically comprises an accumulator 7 followed by an insertion device 8.

Accumulator device 7 principally comprises two accumulator circuits 71, 72 that are disconnected and superimposed, supplied by a sorting flap 70 which separates documents 13 from envelopes 14 and directs them to an accumulator circuit. Documents 13 destined for piece of mail 100 are superimposed in a packet on upper accumulator circuit 71, for example, while corresponding envelope 14 waits on lower accumulator circuit 72. Upper accumulator circuit 71, in the example shown, is completed by a system 73 for folding document 13 or packet of superimposed documents 13 to format them for envelope 14. The two accumulator circuits 71, 72 reconnect at insertion device 8 where folded documents 13 are deposited on the as yet unformed envelope 14.

Insertion device 8 principally comprises a system 80 for folding envelope 14 around folded documents 13. It may be completed by one or more storage areas 81, 82 holding additional documents 18, 19 that are added to folded documents 13 before closing envelope 14, circulating from one station to the other on a conveyor belt 83. Obviously these storage areas 81, 82 may be located on other areas of production machine 1.

In an embodiment that is not shown, accumulator device 7 does not comprise any system for folding documents 13 and insertion device 8 is designed to simultaneously fold documents 13 and envelope 14 with or around possible additional documents 18, 19.

Closing zone D comprises in particular a gluing and folding device 9 for flaps 16, 17 on envelope 14 to close the piece of mail 100. This gluing and folding device 9 principally comprises glue nozzles 90 for depositing glue on lateral flaps 16 of envelope 14, followed by folding ramps 91, 92 for folding these lateral flaps 16 onto or below the back of envelope 14. It also comprises a glue nozzle 93 for depositing glue on closing flap 17 followed by folding ramps 94, 95 for folding said closing flap 17 on the back of envelope 14, sealing the piece of mail 100. During the gluing and folding process, the piece of mail 100 is transported from one station to the other by a conveyor belt 96, and then transported to storage zone E where it is held before being dispatched, or transported directly to a dispatch zone (not shown). A postage metering device (not shown) for mail 100 combined with a weighing device may be integrated into storage zone E. Similarly, a control device (not shown) may complete this production machine 1 to verify the integrity of pieces of mail 100, for example, using a camera to read the OMR, OCR type codes, bar codes, etc. printed on envelope 14.

Optionally, in response to certain requirements imposed by the configuration of certain printing machines, closing zone D as described above may comprise, as shown in more detail in FIGS. 1A through 1E, a zone D1 for closing lateral flaps 16 of envelopes 14, an angled return zone D2, and a zone D3 for closing the closing flap 17. Formed envelopes 14 with their lateral flaps 16 folded and containing documents 13 are evacuated from zone D1 into angled return zone D2 where they follow a trajectory that forms a 90° angle relative to the trajectory they followed in zone D1 and they are positioned along a reference stop.

Zone D3 for closing flap 17, shown in the enlarged view of FIG. 1B, functions first, to score closing flap 17 in order to facilitate folding; second, to apply glue to closing flap 17; third, to trim away the excess 17a from closing flap 17 and evacuate it; fourth, to fold closing flap 17 and apply the glued surface against the back of envelope 14 in order to close it and allow it to proceed toward the outlet of the machine. It should be noted that the various operations defined above could be performed partly simultaneously or in a different order from the above order. For safety and maintenance reasons, it is preferable to avoid the risk of dispersing glue at the time glue is applied and the risk of gumming up mechanical equipment such as the cutting devices. The sequence will be chosen accordingly.

FIG. 1C shows the means 110 and 120 used to perform scoring of the closing flap 17 and cutting off the excess 17a from said closing flap 17 of envelope 14. The mechanical means 110 and 120 are shown in detail in FIGS. 1D and 1E, illustrating the components in perspective and in cross-section, respectively. Said means 110 comprises a support 111 holding a scoring tool 112 and a scoring roller 113 used to contact the peripheral surface of scoring tool 112. Envelope 14 passes between scoring tool 112 and scoring roller 113 and the scoring operation takes place along closing flap 17 to facilitate folding this flap against the back of envelope 14. Note that scoring tool 112 comprises an axle 114 freely engaging a notch 115 of an arm 116 on support 111 to facilitate its replacement.

Said means 120 comprises a support 121 holding a cutting blade 122 and a counter-cutting blade 123 contacting the peripheral surface of cuffing blade 122. These two components cooperate to cut off the excess in the form of a strip, shortening closing flap 17 on envelope 14 and reducing its length by several centimeters, equivalent to the flaps on conventional envelopes.

FIG. 2C represents a width of paper 10′ with two strips A and B printed on it. In band A the section shown comprises a first document A1 followed by a second document A2 to be introduced inside an envelope E10, then a third document A3 a fourth document A4, and a fifth document A5 to be introduced inside an envelope E20. In strip B the section shown comprises a document B1 to be introduced into an envelope E11, then a second document B2 and a third document B3 to be introduced inside an envelope E21, then a fourth document B4 to be introduced into an envelope E31. Note that all the documents and all the envelopes have the same format, for example A4 format, which may require that closing flap 17 on envelopes E10, E20, E11, E21, and E31 be trimmed, as explained above.

FIG. 2D represents a plane view of envelope 14 before folding and closing. Said envelope 14 comprises a front surface 14a, a back 14b, lateral flaps 16 and a closing flap 17. Excess 17a is trimmed from initial closing flap 17 when envelope 14 is formed from a sheet of the same size as documents 13, for example, A4 format.

FIG. 2E shows the same envelope 14 as in FIG. 2D, but defines the various utility areas. Back 14b may comprise codes or designation information. Front surface 14a comprises a postage zone 140, a recipient address zone 141, two address detection zones 142 and 143, an indexing zone 144, and a zone 145 whose use is left up to the sender's discretion. Closing flap 17 extends into excess 17a that will fall away after trimming.

### POSSIBILITIES FOR INDUSTRIAL APPLICATION

These working zones A through E preferably constitute independent modules, facilitating a design and assembly in a configuration that can be adapted by each user, making production machine 1 very flexible and adaptable. Similarly, these modules may be assembled in a series to form a continuous production line as shown in FIG. 1, or certain modules may be separate from others, forming a discontinuous line, for example, the module of printing zone A.

Production machine 1 is controlled by a central processing unit (not shown) using a computer program corresponding to the shape 12 of the strip of paper to be processed, which may or may not depend upon signals delivered by sensors detecting indices printed on width of paper 10 or on strip of paper 11 to identify documents 13 and envelopes 14. This computer program also allows all types of unique, personalized mailing inserts to be produced, with the number and format of the documents and the envelope for each piece of mail programmable as variable data, offering great flexibility and creativity.

The present invention is not limited to the exemplary embodiment described, but extends to any modification and variation obvious to a person skilled in the art while remaining within the scope of protection defined in the attached claims.

1-25. (canceled)

26. A method for producing pieces of mail (100) having an initial width of material (10, 10′) and ending with a closed piece of mail, each piece of mail (100) comprising at least one printed document (13) and one printed envelope (14), a number and format of the printed document (13) and the printed envelope being variable from one piece of mail (100) to a next and the documents (13) to be inserted and the envelopes (14) destined to contain the at least one printed document are printed on the same width of material (10, 10′), one after an other, in an order of insertion with each envelope being one of preceded and followed by the at least one document it will contain, the method comprising the steps of:
trimming longitudinal edges of the width of material (10, 10′) to make the documents (13) have a correct length and to form lateral flaps (16) of the envelopes (14);
cutting the width of material (10, 10′) transversely to separate the documents (13) from the envelopes (14) and to make them the correct length;
assembling the documents (13) with a corresponding envelope (14);
closing the piece of mail (100) thus obtained; and
regulating at least the cuffing step and the trimming step according to a number and format of the documents and envelopes to be stuffed.

27. The method according to claim 26, further comprising the step of printing the documents and the envelopes before the steps of trimming, cuffing, assembling, and closing the piece of mail to form a discontinuous process.

28. The method according to claim 26, further comprising the step of continuously printing the documents and the envelopes with the steps of trimming, cutting, assembling, and closing the piece of mail to form a continuous process.

29. The method according to claim 26, further comprising the step of printing two parallel strips (11, 11′) of documents (13) and envelopes (14) from the same width of material (10′).

30. The method according to claim 26, further comprising the step of separating the documents (13) and the envelopes (14) into two distinct circuits before the step of assembling.

31. The method according to claim 30, further comprising the step of superimposing, in packets, the at least one document (13) to be contained in the envelope (14).

32. The method according to claim 31, further comprising the step of superimposing, during the assembly step, the at least one document (13) on the corresponding envelope (14) such that the documents and the envelope are simultaneously folded.

33. The method according to claim 31, wherein the at least one document (13) to be contained in the same envelope (14) are folded into a format of the envelope (14).

34. The method according to claim 33, further comprising the step of superimposing, during the assembly step, the at least one folded document (13) on the corresponding envelope (14) such that the envelope (14) is folded around the at least one document (13).

35. The method according to claim 30, further comprising the step of superimposing additional separately prepared documents (18, 19) on the at least one document (13) and the envelope (14).

36. A method of producing a closed piece of mail (100) from an initial width of material (10, 10′), each piece of mail (100) comprising at least one printed document (13) and one printed envelope (14), while a number and a format of the at least one document and the envelope are variable from one piece of mail to a next; the at least one document (13), to be inserted into the envelope, and the envelope (14), to contain the at least one document, are printed from the same width of material (10, 10′), one after another, in an order of insertion, with each of the envelopes being one of preceded and followed by the at least one document which the envelope will contain, the method comprising the steps of:
trimming longitudinal edges of the width of material (10, 10′) to make the at least one document (13) a correct length and to form lateral flaps (16) of the envelopes (14);
cutting the width of material (10, 10′) transversely to separate the at least one document (13) from the envelopes (14) and to make the at least one document (13) and the envelopes (14) the correct length;
assembling the at least one document (13) with the corresponding envelope (14);
simultaneously folding the at least one document (13), which correspond to the envelope (14), and the envelope (14);
lateral folding flaps of the envelope (16);
trimming an excess (17a) of a closing flap (17);
after the excess (17a) has been trimmed, gluing and folding the closing flap (17);
closing the glued closing flap (17) to obtain the piece of mail (100); and
regulating at least the trimming and the cutting steps according to a number and format of the at least one document and the envelopes to be stuffed.

37. The method according to claim 36, further comprising the step of the scoring the lateral envelope flaps (16) before the lateral envelope flaps (16) are glued and then folded.

38. The method according to claim 36, further comprising the step of scoring the closing flap (17) before the closing flap (17) is glued and then folded.

39. A machine (1) for producing closed pieces of mail (100) beginning with an initial width of material (10, 10′), each piece of mail (100) comprising at least one printed document (13) and one printed envelope (14), a number and a format of the at least one document and the envelope being variable from one piece of mail to a next, the machine comprising:
at least one printing device (2) for printing, on the same width of material (10, 10′), the at least one document (13) to be inserted into the envelope, and the envelopes (14), to contain the at least one document, one after the other, in an order of insertion, with each of the envelopes being one of preceded and followed by the at least one document to be inserted therein;
a longitudinal cutting device (3) for trimming the at least one document to a correct width and forming the flaps (16) of the envelopes (14);
a transverse cutting device (4) for separating the at least one document (13) from the envelope (14) and cutting the at least one document and the envelope to a correct length;
an assembly device (7, 8) for assembling the at least one document (13) and the corresponding envelope (14);
a gluing and folding device (9) for closing the piece of mail (100) thus obtained; and
a central processing unit to regulate at least the longitudinal cutting device (3) and the transverse cutting device (4) according to the number and the format of the at least one document and the stuffed envelopes to be produced.

40. The machine according to claim 39, wherein the printing device (2) is independent from at least one of the longitudinal cuffing device (3), the transverse cuffing device (4) the assembly device (7, 8), the gluing and folding device (9) and the central processing unit thus forming a discontinuous production machine.

41. The machine according to claim 39, wherein the printing device (2) is integrated with and on line with the longitudinal cutting device (3), the transverse cutting device (4), the assembly device (7, 8), the gluing and folding device (9) and the central processing unit thus forming a continuous production machine.

42. The machine according to claim 39, wherein the assembly device comprises at least one accumulator device (7) for separating the at least one document (13) from the envelopes (14) into two distinct accumulator circuits (71, 72) and for assembling the at least one document (13) with a corresponding envelope (14) by superimposing the at least one document (13) and the corresponding envelope (14).

43. The machine according to claim 42, wherein the accumulator device (7) superimposes the at least one document (13), to be contained in the envelope (14), in a packet.

44. The machine according to claim 42, wherein the assembly device comprises at least one insertion device (8) which simultaneously folds the at least one document (13) and the envelope (14).

45. The machine according to claim 42, wherein the accumulator device (7) comprises a folding system (73) for folding the at least one document (13) into the format of the envelope and the assembly device comprises at least one insertion device (8) for folding the envelope (14) around the at least one folded document (13).

46. The machine according to claim 39, wherein the machine comprises at least one storage area (81, 82) for storing separately prepared additional documents (18, 19), which are to be added to the at least one document (13) and the envelope (14).

47. The machine according to claim 42, wherein the machine comprises at least one of a postage device, for metering closed pieces of mail (100), and a device for controlling an integrity of the closed pieces of mail (100).

48. A machine (1) for producing closed pieces of mail (100) beginning with an initial width of material (10, 10′), each piece of mail (100) comprising at least one printed document (13) and one printed envelope (14), a number and format of the at least one document and the envelope being variable from one piece of mail to a next, the machine comprising:
at least one printing device (2) for printing, on the same width of material (10, 10′), the at least one document (13) to be inserted into the envelope, and the envelopes (14), to contain the at least one document, one after the other, in an order of insertion, with each of the envelopes being one of preceded and followed by the at least one document to be inserted therein;
a longitudinal cutting device (3) for trimming the at least one document to the correct width and forming the flaps (16) of the envelopes (14);
a transverse cutting device (4) for separating the at least one document (13) from the envelope (14) and cuffing the at least one document and the envelope to a correct length;
a scoring means (110 and 120) for scoring and trimming of a closing flap (17) of the envelope (14);
an assembly device (7, 8) for assembling the at least one document (13) and the corresponding envelope (14);
a gluing and folding device (9) for closing the piece of mail (100) thus obtained; and
a central processing unit for regulating at least the longitudinal cutting device (3) and the transverse cutting device (4) according to the number and the format of the at least one document and the stuffed envelopes to be produced.

49. The machine according to claim 48, wherein the scoring means (110) comprises a support (111) that holds a scoring tool (112) and a scoring roller (113) contacting a peripheral surface of the scoring tool (112).

50. The machine according to claim 48, wherein the scoring means (120) comprises a support (121) holding a cutting blade (122) and a counter-cutting blade (123) that contacts a peripheral surface of the cutting blade (122).
